(19) United States
(12) Patent Application Publication
(10) Pub. No.: US 2024/0257110 A1
(43) Pub. Date: Aug. 1, 2024

(54) SYSTEM AND METHOD FOR CIRCUMNAVIGATION OF A BLOCKCHAIN BASED TOKEN EXCHANGE

(71) Applicant: SEMIOTIC AI, INC., Los Altos, CA (US)

(72) Inventor: Matthew Deible, Los Altos, CA (US)

(21) Appl. No.: 18/159,855

(22) Filed: Jan. 26, 2023

(51) Int. Cl. G06Q 20/38; G06Q 20/36

(52) U.S. Cl. CPC G06Q 20/381; G06Q 20/36; G06Q 2220/00

(57) ABSTRACT

A system and method for a blockchain circumnavigation process includes: generating a blockchain token based graph (BTBG), comprising nodes representing blockchain tokens and edges representing exchanges between blockchain tokens; initializing a circumnavigation process; and constructing a method circumnavigation. Initializing the circumnavigation process may include: determining a cycle node; determining a circumnavigation length, a maximum number of edge traversals for the circumnavigation; determining all circumnavigation paths, from and to the cycle node not exceeding the circumnavigation length; and determining a cycle node distribution, i.e., how the cycle node value is distributed along each step of each circumnavigation path. Constructing a method circumnavigation, comprises an iterative process that includes: simulating all circumnavigation paths; calculating an exchange efficiency for each token exchange; and updating the cycle node distribution. The method functions to determine a “best” circumnavigation for a token exchange on blockchains from and to the cycle node.

### TECHNICAL FIELD

This invention relates generally to the field of decentralized finance, and more specifically to a new and useful system and method for circumnavigating blockchain based token exchanges.

### BACKGROUND

With bitcoin's fairly recent blockchain innovation and the advent of Turing complete decentralized computation with Ethereum's smart contracts, the field of decentralized finance has exploded. Decentralized exchanges (DEXs) provide marketplaces that are transparent, more tamper-proof compared to centralized exchanges, and allow open and fair participation by all parties. With the rapid growth of these markets and the creation of so many currencies (i.e., tokens), navigating trades on these markets has developed much further from simple currency/token swaps on a single exchange. Although there are many dApps (decentralized applications) that enable transactions and provide analytics for token exchanges, there has been little progress made to evaluate more complex multi-token and/or multi-DEX transactions, where exchanging through intermediary tokens and splitting among many DEXs are also analyzed.

Thus, there is a need in the field decentralized finance to create a new and useful system and method for complex multi-token analysis and exchange in decentralized markets. This invention provides such a new and useful system and method.

### BRIEF DESCRIPTION OF THE FIGURES

FIG. 1 is a flowchart representation of a first method.

FIG. 2 is a flowchart representation of a second method.

FIG. 3 is an example blockchain token based graph for multiple blockchains.

FIG. 4 is an example blockchain token based graph.

FIG. 5 is an example blockchain token based graph.

FIG. 6 is an example blockchain token based graph representation with multiple liquidity pools incorporated into a single edge.

FIG. 7 is an example blockchain token based graph where each liquidity pool corresponds to a graph edge.

FIG. 8 is an example blockchain token based graph over multiple blockchains where each liquidity pool corresponds to a graph edge.

FIG. 9 is an example blockchain token based graph with four nodes.

FIG. 10 is a tensor description of the edges of FIG. 7 for each path step for an implementation of three time steps.

FIGS. 11-14 is a graph traversal of the blockchain token based graph of FIG. 7 for an implementation of three time steps.

FIG. 15 is a tensor description of the edges of FIG. 7 for a circumnavigation of length 2, where paths not ending at the cycle node have been pruned.

FIGS. 16-17 is an updated circumnavigation of the blockchain token based graph of FIG. 7 with a circumnavigation length of 2 (three time steps).

FIGS. 18-21 is a circumnavigation of an example four node blockchain token based graph with a circumnavigation length of 2 (three time steps).

FIGS. 22-25 are is a circumnavigation of an example multi-blockchain blockchain token based graph with a circumnavigation length of 2 (three time steps).

FIG. 26 is an exemplary system architecture that may be used in implementing the system and/or method.

FIG. 27 is a second example architecture that may be used in implementing the system and/or method.

### DESCRIPTION OF THE EMBODIMENTS

The following description of the embodiments of the invention is not intended to limit the invention to these embodiments but rather to enable a person skilled in the art to make and use this invention.

### 1. Overview

A method for pathfinding an efficient circumnavigation, to and from a cycle node, on a plurality of liquidity sources (e.g., liquidity pools from one or more decentralized exchanges (DEX)) includes: from the plurality of liquidity sources, generating a blockchain token based graph, comprising nodes representing blockchain tokens and edges representing exchanges between tokens; initializing a circumnavigation process, including determining the cycle node and the circumnavigation path length; and constructing a method circumnavigation, by iteratively simulating all eligible circumnavigations to and from the cycle node, calculating an exchange efficiency for each token exchange step of all circumnavigations, and using the exchange efficiencies, to update future circumnavigations. The method functions to determine favorable circumnavigations between from and to the cycle node/token by applying an iterative smart order routing (SOR) optimization to the pathing.

As a processor based implementation, for one or more processors with an interface to one or more blockchains and computer readable medium storing machines, a method for pathfinding an efficient circumnavigation, to and from a cycle node, on a plurality of liquidity sources (e.g., liquidity pools from one or more decentralized exchanges (DEX)) includes: at the one or more processors and at the computer readable medium storing machines, generating a blockchain token based graph, from the liquidity sources; at the one or more processors, initializing a circumnavigation process; and at the one or more processors, constructing a method circumnavigation.

The generated blockchain token based graph comprises nodes, that represent tokens on one or more blockchains; and edges, that represent liquidity sources. An automatic market maker (AMM) function may define each edge, providing the state-dependent “exchange rate” at which tokens can be converted (swapped/exchanged) between the connected nodes. Simulating all circumnavigation paths comprises a graph traversal, by traversing in a step-wise fashion (from one node to all neighboring nodes, per step), from and to the cycle node.

Constructing a method circumnavigation path includes iterations of: after each full graph traversal, determining the exchange efficiency of each path step (e.g. through gradient calculations), followed by adjusting the exchange amount of each path step (e.g. through gradient descent), followed by the optional step of removing distinctly non-favorable edges from the blockchain token based graph. As the edges represent complex exchange functions set by finite liquidity sources, a single path may not be the optimal circumnavigation of the blockchain token based graph.

The method may be applied generally in the field of decentralized finance to evaluate and/or initiate trades using decentralized exchanges (DEXs) or other liquidity sources. The method is particularly applicable for implementations using DEXs or other liquidity sources on public distributed ledgers, where favorable token trades, potentially through intermediary tokens, may be determined and implemented.

The system and method may provide a number of potential benefits. The system and method are not limited to always providing such benefits and are presented only as exemplary representations for how the system and method may be put to use. The list of benefits is not intended to be exhaustive and other benefits may additionally or alternatively exist.

The system and method provide the potential benefit of an efficient product that determines optimal order routes and applies them in a short enough time frame prior to significant state changes of most distributed ledger technology, especially blockchains.

Additionally, the system and method provide the benefit of finding complex optimal paths between tokens. That is, system and method may find favorable swap paths that include using multiple decentralized exchanges or other liquidity sources and multiple paths simultaneously.

Furthermore, the method provides a means of judging the general health and stability of DEXs, and more generally blockchains. By measuring and determining maxima/minima properties of circular path exchanges to and from a single node (cycle node), imbalances of the DEX may be discovered.

Although many optimization products have been constructed for optimizing routing through decentralized liquidity sources, current popular products provide inefficient and suboptimal solutions that are unable to fully and precisely search the full complex space of possible paths through decentralized liquidity sources. The system and method provide the potential benefit of a continuous optimization that enables capturing the complexity of large numbers of decentralized liquidity sources and their corresponding automatic market maker (AMM) functions. The system and method may leverage properties of distributed ledger technologies (DLTs) to find/generate and initiate optimized exchanges that may not have been previously observed or possible. As one potential benefit with respect to DLTs, the system and method may access, generate token based graphs, and initiate exchanges for liquidity sources over multiple distributed ledgers.

### 2. Method

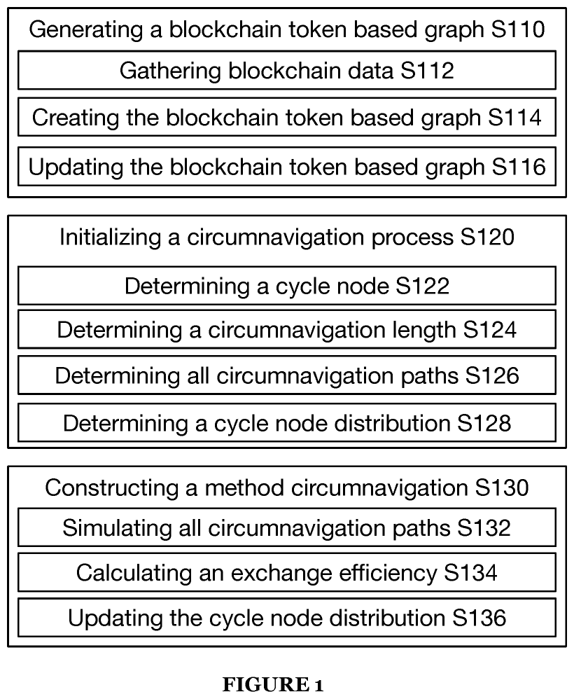

As shown in FIG. 1, a method for a multi-blockchain circumnavigation process includes: generating a blockchain token based graph S110, wherein the blockchain token based graph comprises nodes representing blockchain tokens and edges representing exchanges between blockchain tokens; initializing a circumnavigation process S120 on the blockchain token based graph; and constructing a method circumnavigation S130 on the blockchain token based graph.

Initializing the circumnavigation process S120, may further include: determining a cycle node S122, the start and end point of the circumnavigation process, comprising setting a cycle node token value; determining a circumnavigation length S124, comprising a maximum number of node traversals for circumnavigating the blockchain token based graph; determining all circumnavigation paths S126, from the cycle node, not exceeding the circumnavigation length, and determining a cycle node distribution S128, wherein the cycle node distribution sets how the cycle node token value is distributed along each step of each circumnavigation path.

Constructing a method circumnavigation S130, may comprise an iterative process on the blockchain token based graph, wherein each iteration includes: simulating all circumnavigation paths S132; calculating an exchange efficiency S134, for each token exchange along all circumnavigation paths; and updating the cycle node distribution S136, based on the exchange efficiencies.

The method functions to determine and evaluate a “best” path (i.e., the method path), or paths, for a token exchange on one, or more, blockchains starting and ending on the same node (i.e., the cycle node); wherein the path(s) may extend through any number of intermediary nodes ranging from at least two nodes and not to exceed the circumnavigation length.

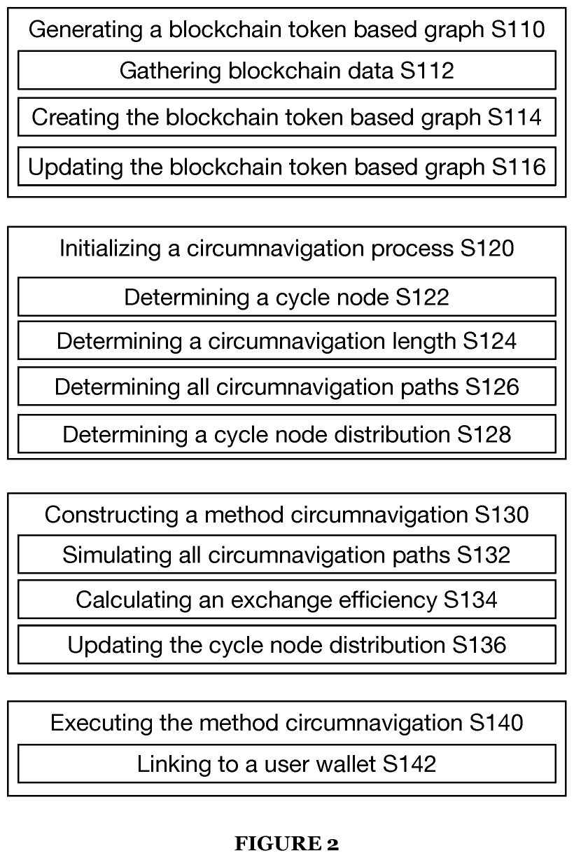

In some variations, the method may further function to execute the method circumnavigation. That is, the method may function to determine, evaluate, and apply the method circumnavigation to the blockchain(s), thereby executing all exchanges of the method circumnavigation on the applicable blockchain(s). As shown in FIG. 2, in these variations the method may include: generating a blockchain token based graph S110, wherein the blockchain token based graph comprises nodes representing blockchain tokens and edges representing exchanges between blockchain tokens; initializing a circumnavigation process S120 on the blockchain token based graph; constructing a method circumnavigation S130 on the blockchain token based graph, and executing the method circumnavigation S140, on the blockchains used to generate the blockchain token based graph.

As a multi-blockchain based process, unless explicitly stated otherwise, any reference to a blockchain, may equally refer to any number of blockchains and/or distributed ledger technologies (DLTs). That is, blockchain may refer to any blockchain(s), or distributed ledger technology platform(s) or source(s). Unless a specific platform is discussed, blockchain, or any blockchain attribute (e.g., blockchain token), may generally refer to any private, public, local, cloud-based, etc. blockchain and/or distributed ledger technology. As used herein, blockchains are broadly defined as any system that incorporates a ledger that includes liquidity source data. Examples of potential blockchains include: distributed ledgers, centralized ledgers, decentralized ledgers, blockchains, Merkle trees, directed acyclic graphs (DAGs), Optimistic, Zero Knowledge, or other rollup technology and other layer 2 scaling solutions, etc.

Generally, a blockchain comprises a platform where all transactions occur in immutable “blocks” of data, wherein these blocks are determined and checked through a distributed ledger system. On the blockchain, the latest state of the system is determined with each addition of a block (i.e., block update). Each block addition is completed through some consensus mechanism. Examples of consensus mechanisms include: Proof of Work, wherein participants compete to solve computationally expensive puzzles in order to decide the next block; and Proof of Stake, wherein participants are chosen randomly to add the next block with a probability proportional to the amount of economic value they have staked; or any other mechanism in which participants can use some scarce resource in order to be selected to add the next block. The time required for each block update may be dependent on the specific blockchain, the complexity of the added block, and potentially other factors. In some cases, block updating takes on the order of minutes or 10s of minutes (e.g., bitcoin). The range block updating may vary significantly, and in other cases may only take up to a few seconds. With respect to the blockchain, the method runs to completion at a time scale faster than block updates of blockchains. That is, the method functions to connect to one or more blockchains, identify favorable token swaps, and execute those token swaps to completion on the order of seconds.

As the method is a process for blockchain based token exchanges, the method may be implemented for any system that includes liquidity sources. Many liquidity sources can be found in groups know as decentralized exchanges (DEXs). The method may connect to the corresponding blockchains to read the current states of liquidity sources on the DEX, construct a blockchain token based graph, and iteratively traverse the blockchain token based graph to determine an “optimal” swap path circumnavigation for one, some, or all tokens. As used herein, a DEX is a platform that enables a market exchange without intermediaries. A DEX is a protocol that uses smart contracts to facilitate trading between tokens on one or more blockchains, wherein each token that can be swapped on the DEX is defined by its own smart contract, or otherwise defined on the blockchain in question. The method may alternatively be implemented on other types of exchanges (e.g., centralized exchanges).

In many variations, liquidity sources may be on exchanges (e.g., decentralized exchanges (DEXs) and centralized exchanges (CEXs)) based on blockchains. The method may be implemented on any and/or all decentralized exchanges or other liquidity sources on one, or multiple, blockchain sources. The method may be implemented on any type of “blockchain”, (e.g., public, private, blockchain, rollup, hashgraph, DAG, Holochain, etc.) that enables the incorporation of decentralized markets. Examples of public blockchains include: Ethereum, Binance Smart Chain, Bitcoin, EOS, Hedera Hashgraph, Solana, Avalanche, Fantom, Polygon, Arbitrum, Optimism, zkSync, xDai, Harmony, Tron, Celo, Tezos, Near, Moonriver, etc.

The method may be implemented with a system that includes: a processor system comprising one, or more, hardware processors with interfaces to all blockchains considered, and a computer readable medium (e.g., a non-transitory medium) storing machine instructions, where when executed cause the hardware processors to perform the operations described herein. Thus, the method may comprise: on the computer readable medium storing machine, generating a blockchain token based graph S110, further comprising connecting to a blockchain source; at the processor system, initializing a circumnavigation process S120; and at the processor system configured to perform iterative processing, constructing a method circumnavigation S130, therein iteratively simulating all circumnavigation paths, calculating an exchange efficiency along all circumnavigation paths, and modifying the cycle node distribution based on the exchange efficiencies.

Generally, the method may be implemented with a system that includes a wallet (also referred to as electronic wallet or crypto-wallet), wherein the wallet “contains” the cycle token, and/or cycle token intermediaries. This may be particularly the case for method variations that includes execution of the method circumnavigation S140 on the blockchain. As used herein, a wallet is a storage device that “contains” some amount of a token if that wallet stores the private keys corresponding to a public address with a balance of that amount, or otherwise has some mechanism allowing the user to send or transact the specified amount of token on the relevant blockchain. Thus, in some variations, the method may include: setting up a wallet associated with the desired blockchain. The wallet may correspond to a public address, enabling the transfer of funds to the wallet. The method may be implemented with both hardware (locally owned) wallets and software (app-based) wallets. Thus, setting up a wallet associated with the desired DLT source(s) comprises obtaining (e.g., by purchase) a desired amount of start token and storing the private key used to transact the start token in the wallet.

In some variations, the method may be implemented as a service. That is, upon a user request, for a given token value of a user owned cycle token, the service determines an “optimal” method circumnavigation and provides data for executing the circumnavigation, or executes the method circumnavigation for the user. As shown in FIG. 2, in these variations, executing the method circumnavigation may further include linking to a user wallet S142, wherein the wallet contains some amount of the cycle token; and via the method determined path, executing the method circumnavigation comprises: using the wallet cycle token in executing, on the blockchain, all exchanges of the method circumnavigation, starting and ending at the cycle token, thereby updating the wallet cycle token value. As part of executing the method circumnavigation S142, token exchanges to and from the cycle node may further comprise: at the blockchain interface, sending an exchange request, and at the blockchain interface, reading the resulting included transaction that includes swaps for all intermediary tokens and the target token. In variations, including where the user does not provide a wallet, the method may additionally include setting up a user wallet (e.g., an app-based wallet) or taking the cycle token from another source (e.g., a smart contract or smart contract function).

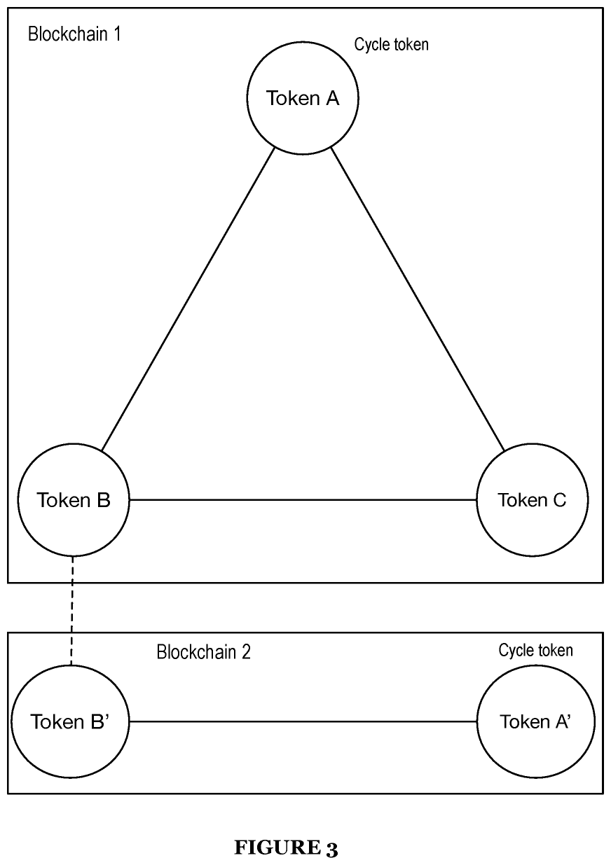

As used herein, a circumnavigation, or circumnavigation path, refers to a graph based traversal with the same starting and ending token (i.e., the cycle node or cycle token). As the defining characteristic of the circumnavigation is the actual token, from a graphic representation, in some variations, the actual traveled path may not be a circumnavigation. For example, as shown in FIG. 3, a circumnavigation that spans multiple blockchains may comprise a path starting from token A on a first blockchain and ending on token A on a second blockchain. As mentioned above, the method functions to determine and potentially execute a “best” path, or paths, for circumnavigation of the blockchain based graph, which may in this example, be a path to token A on either blockchain. A circumnavigation may additionally traverse from a starting and ending token that have the same value but are not otherwise identical. For example, the starting and ending token may both be redeemable via a one to one exchange for the same underlying asset, e.g. USD.

As used herein, the term path (or circumnavigation path) may refer to any number of paths. Unless stated otherwise, the term path does not place any limitation on the number of paths that are discussed. Thus the term circumnavigation path may refer to any number of paths originating and ending at nodes that satisfy the above definition of a circumnavigation.

Block S110, which includes generating a blockchain token based graph functions to create and update a blockchain token based graph. That is, generating a blockchain token based graph S110 may include: gather blockchain data S112, from one, or more, blockchains; creating the blockchain token based graph S114, from the gathered information; and, dependent on implementation, updating the blockchain token based graph S116, according to updates/changes that occur on the source blockchains.

Gathering blockchain data S112 may be a component of generating a blockchain token based graph S110. Gathering blockchain data S112 functions to acquire the information required to generate the blockchain token based graph, both in creating the blockchain token based graph S114 and updating the blockchain token based graph S116.

Gathering blockchain data S112 may include connecting to a blockchain, thereby accessing information regarding tokens and their corresponding liquidity sources on the blockchain. Connecting to a blockchain may function both to enable transactions on a decentralized marketplace, and to enable gathering blockchain data S112. Connecting to a blockchain may include connecting to one, or multiple, blockchains.

Once connected, gathering blockchain data S112 may include retrieving state data with regards to liquidity sources on the blockchain. The state data may include information regarding liquidity source states on the blockchain, and information regarding one, some, or all tokens on the blockchain. This information may include smart contracts and liquidity pools associated with the tokens. Additional information may be collected as desired per implementation.

In many variations, gathering blockchain data S112 may include reading the state of a DEX on the blockchain. This may include reading the state of a single DEX or multiple DEXs. It may additionally include reading the state of one or more DEXs existing on one or more blockchains. Reading the state of a DEX may occur directly through, e.g., an API for the DEX, and/or through an intermediary application or platform (e.g., using an intermediary decentralized application (dAPP) on a blockchain that interfaces with components of the desired DEX). In some variations, gathering blockchain data S112 may comprise reading the state of the decentralized liquidity sources, which may include reading the state of one or more DEXs or other liquidity sources on one or more blockchains. Examples of possible, current, decentralized liquidity sources include: Uniswap V2 and V3 on Ethereum, Balancer on Ethereum, Polygon, and Arbitrum, Curve on Ethereum, Polygon, Avalanche, Arbitrum and other DLTs, Sushiswap on Ethereum and many other blockchains, EtherDelta on Ethereum, Kyber Network on Ethereum, BSC, Polygon, and Avalanche, etc.

Connecting to a public blockchain to read the state of a DEX or other liquidity source may occur as described above. For example, the Uniswap V2 liquidity pool state data on Ethereum may be read by connecting to an Ethereum node and sending a JSON-RPC request for the latest state of the relevant smart contract storage variables. Alternatively, a third-party data service such as The Graph protocol can be used to query for the most recent state of a DEX or other liquidity source on one or more blockchains. The best method for reading data for a specific DEX or other liquidity source may vary, dependent on the specific case.

In some variations, gathering blockchain data S112 may further include creating a liquidity source (e.g., a DEX). The created DEX, or other liquidity source, may comprise liquidity pools of existing tokens from corresponding blockchains, or may include defining new tokens on a new or pre-existing blockchain. That is, dependent on implementation, the newly created liquidity source may comprise creating a market for already existing tokens, and/or creating new market tokens, i.e., creating new smart contract-based tokens. In some implementations of these variations, a user implemented token based graph may first be generated, and a digital entity market may then be created, on a new or existing blockchain, that mirror the blockchain token based graph.

Generating a blockchain token based graph S110 may include creating a blockchain token based graph S114. That is, once, sufficient blockchain data has been gathered, a blockchain token based graph may be created. In some variations, creating the blockchain token based graph S114 may occur concurrent to gathering blockchain data S112. Alternatively, creating a blockchain based graph S114 may occur once all relevant data has been gathered.

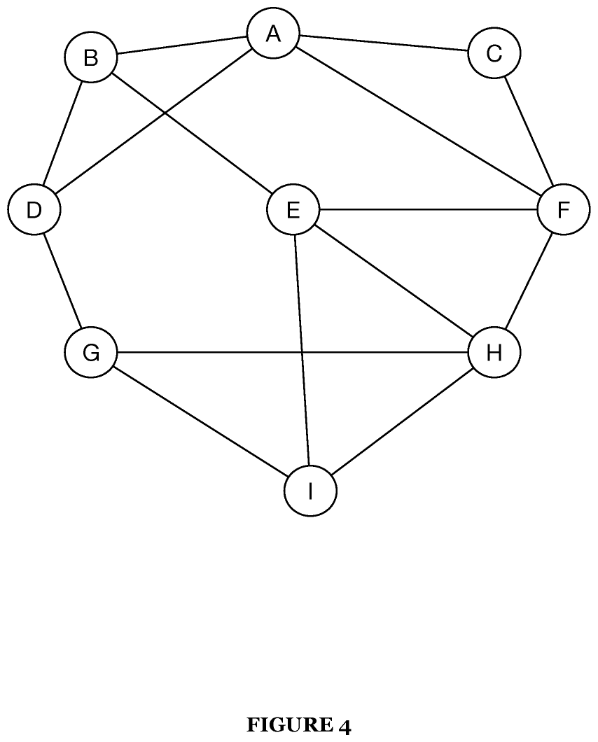

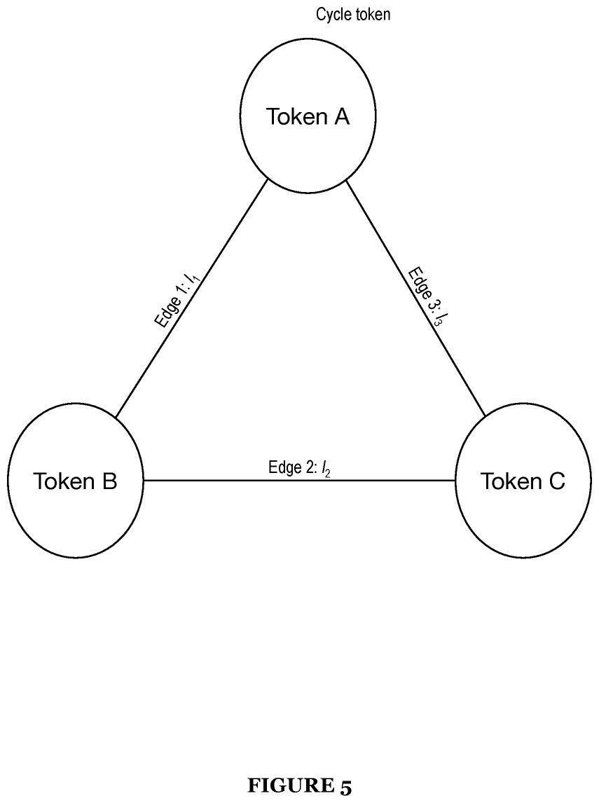

The blockchain token based graph comprises a graph representation of relevant blockchain tokens and token swaps. In some implementations, the blockchain token based graph may be represented as an adjacency list. As shown in the examples FIGS. 4 and 5, the method leverages blockchain source data regarding the state of liquidity sources (e.g., from a DEX) to construct a graph of all tokens (nodes) and edges (liquidity sources) being considered from which all possible paths between the tokens can be constructed. In this representation, each node of the blockchain token based graph represents a token defined on one or more blockchain and edges represent liquidity sources on one or more blockchains that allow transfer of tokens from one node to another as defined by an automatic market maker (AMM) algorithm.

Tokens are represented as nodes on the blockchain token based graph, where each node includes a token value, i.e., the amount of token currently owned by the routing smart contract. As nodes are representation of tokens, as used herein the terms nodes and tokens may be used interchangeably. Commonly, tokens represent cryptocurrencies (e.g. the native coin of a DLT, an ERC20 token on Ethereum and Ethereum scaling solutions or a BEP20 token on Binance Smart Chain), but may additionally, or alternatively, represent other types of currencies (e.g., state currencies such as the US dollar).

On the blockchain token based graph, each token has a token value, a non-negative integer, representing the quantity of the token that the smart contract or other swap executing mechanism will be able to transact at that time. As part of the method, initially the cycle token must have a positive value. In trading implementations with a wallet, the cycle token must be a token that is contained, in sufficient quantity, within the wallet of the user or in some other form that a routing smart contract can receive from (e.g., a flash loan smart contract may be utilized to implement the circumnavigation method, which would then be repaid after the circumnavigation). In variations where multiple blockchains are spanned the wallet must contain (or have access to) some quantity of the cycle node on each spanned blockchain; or the wallet must contain a token (or tokens) on each spanned blockchain, such that these tokens must be able to serve as intermediary nodes for a circumnavigation.

The method may be implemented for multiple cycle tokens, wherein all cycle tokens would have positive starting values. As part of the circumnavigation process, the method ensures that at least one of the cycle tokens has a nonzero final value. As part of the circumnavigation process intermediary tokens may have positive values. This may particularly be the case during intermediary swap executions along the circumnavigation path. Intermediary tokens may have positive values during circumnavigations. In many variations, these intermediary tokens may have zero token value initially and zero token value after the final step. It should be noted, that due to limits in rounding and enforcing partial trades, some tokens may have “relatively” small non-zero values. As used herein, a zero token value refers to a token value less than the fixed-point precision of that token on the relevant blockchains.

In many variations, the method may be implemented with cycle node starting amounts that are also optimized by the algorithm in conjunction with the circumnavigation path. e.g. in conjunction with determining exchange efficiencies, input amount efficiencies may also be determined for each cycle node, and these starting node amounts may then be adjusted in conjunction with the path itself.

In some multiple cycle node variations, a utility may be assigned to each cycle node. The utility of a token may define the benefit each unit of a token provides in a common unit for all tokens. In these variations, the utility weighted sum may be calculated as the total “value” of the token in the chosen common unit. In some examples of these variations, the utility for a token may be the current value of that token in a base currency (e.g., USD or ETH). In these examples, the efficiency of the solution may further be defined as the utility weighted sum of the final values of the cycle nodes minus the utility weighted sum of the initial values of the cycle nodes.

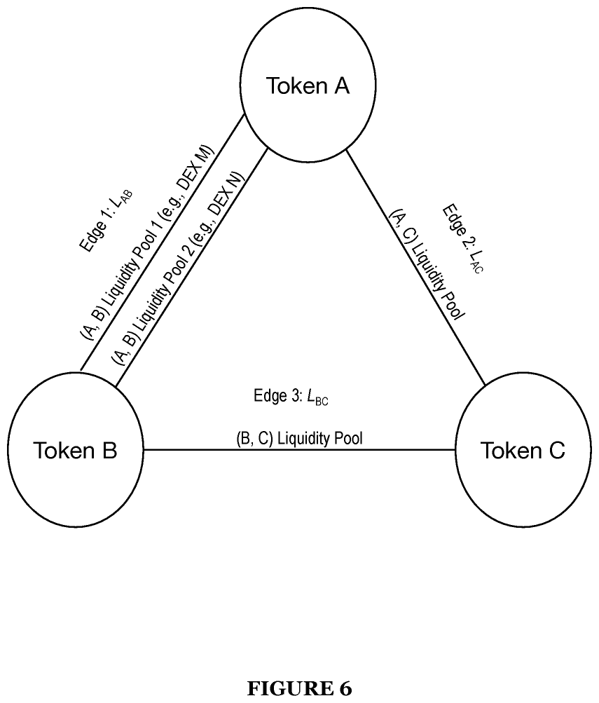

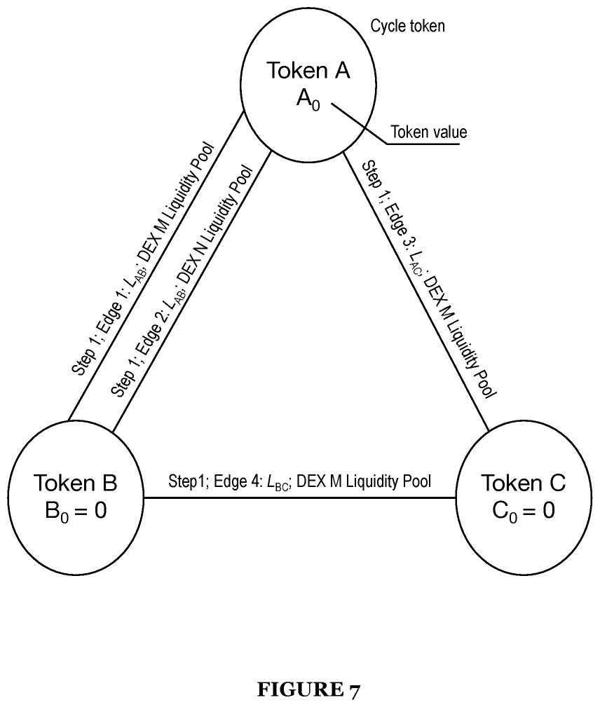

On the blockchain token based graph, edges represent exchanges between tokens (e.g., liquidity sources) that allow some quantity of one token to be swapped for another token as defined by the swap. These swaps may be defined from the extracted blockchain data. In many variations, the exchange represents some liquidity source, wherein tokens are swapped according to their automated market maker (AMM) function using liquidity provided by other users, or otherwise defined within a smart contract on the blockchain. As shown in FIG. 5, liquidity sources may be represented as edges on the blockchain token based graph. An edge may be directed or bidirectional, depending on the mechanics of the corresponding liquidity source. Liquidity pools may represent constant, or varying exchange rates. Generally, liquidity pools represent state dependent functions that update as tokens are exchanged through the liquidity pool. The exchange rate may additionally change depending on the amount of value being exchanged. Thus, each edge may represent a constant rate or a more complex function (e.g., a convex function with multiple state variables) of amount being traded and/or any number of other liquidity source specific state variables. In variations where multiple types of liquidity sources are used, nodes may have multiple liquidity sources connecting them. In some of these variations, as shown in example FIG. 6, multiple liquidity pools may be modeled as a single edge on the blockchain token based graph. Alternatively, as shown in FIG. 7, each liquidity pool on the blockchain token based graph may be represented by a distinct edge, allowing two nodes to have multiple edges connecting them. Without loss of generality, for simplicity, this document will further on only present examples of the blockchain token based graph where each liquidity pool is represented by an edge.

In some versions, liquidity sources involving more than two tokens may be considered. In some cases, such liquidity sources will allow any token in the pool to be swapped for any other token while utilizing a subset of the same set of AMM parameters. In some cases there may be limitations on which pairs of tokens can be swapped. In some implementations, a multi-token liquidity source may effectively function as several independent edges, provided no AMM parameters are reused on the same traversal step. For instance, a three token pool with tokens A, B, and C may be represented as a set of 6 swaps: A->B, A->C, B->A, B->C, C->A, and C->B, so long as only one such swap is used at each point on the traversal in the final selected path. Alternatively, a multi-token pool may be represented as a multi-dimensional edge with multiple inputs and multiple outputs. Without loss of generality, for simplicity, this document will further on only present examples of simple two-token edges in blockchain token based graph and sample graph traversals.

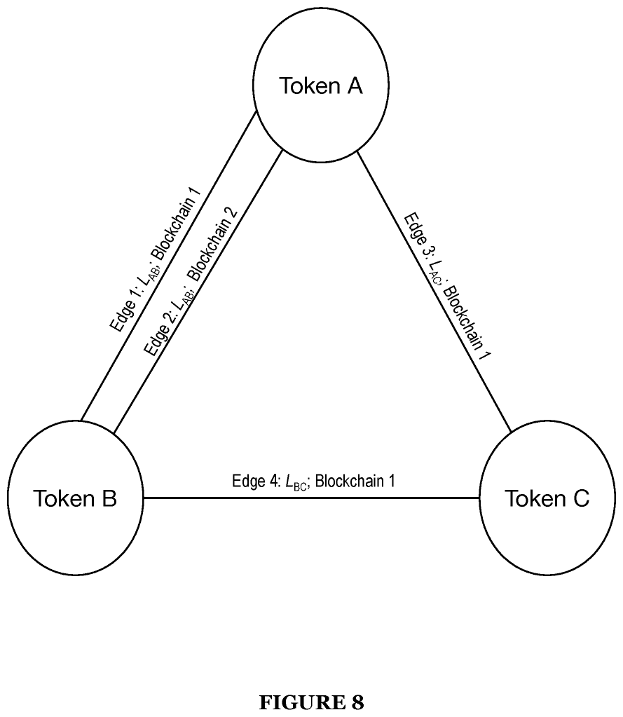

As mentioned above, the blockchain token based graph may span tokens over multiple blockchains. In some implementations for a plurality of blockchains, the blockchain token based graph may have multiple representations for the same token (e.g., as shown in FIG. 3, where token A and token A′ represent the same token but on two different blockchains). As shown in FIG. 8, an alternate implementation of the same example as FIG. 3, each token may be represented only once, wherein distinct blockchain exchanges are represented through multiple edges between the nodes. It should be noted, that multiple edges may also be incorporated for multiple liquidity pools between tokens on the same blockchain in an analogous fashion to FIG. 7. Thus, in some implementations, the blockchain token based graph may include multiple edges between nodes (e.g., for different liquidity pools on the same blockchain); and the same node (from distinct blockchains) may be present multiple times.

The method may be implemented for distinct sets of the same cycle token. That is, for cycle tokens located on different exchanges or blockchains. For example, in one method implementation, the cycle token may include a certain quantity of cycle token (e.g., USD coin) on the Ethereum blockchain, and another certain quantity on the Polygon blockchain. In some implementations a certain amount of each cycle token may be specified; in other implementations the exact amounts of each cycle token may instead be optimized along with the traversal parameters. For example, a total amount of starting USD coin may be specified while the algorithm is allowed to optimize the proportion of that total amount that begins on each blockchain being considered. More complex cycle token arrangements are also possible.

Additionally, for multi-blockchain circumnavigations, the method may require access to tokens on all blockchains. That is, the user must have (or have access to) a wallet on each blockchain with access to some “sufficient” value of tokens, either directly attributed to that wallet or otherwise accessible through a smart contract function (or similar) on that blockchain. Preferably, the token held on each blockchain is the transfer point between the blockchains, e.g., token B′ as shown in FIG. 3; such that once a circumnavigation reaches a token B, the algorithm may equally propagate the circumnavigation from token B′ and token B. Thus the limitation on multi-blockchain circumnavigations, is that for any implementation, the algorithm must have access to sufficient liquidity on each blockchain to execute a sufficient quantity exchange on that blockchain.

The blockchain token based graph may be dependent on the state of the blockchain. For example, for a given blockchain, constructing a blockchain or an update to a blockchain may preferably lead to updating the blockchain token based graph. That is, updating the blockchain token based graph S116 may function to update blockchain token based graph in response to a change of state of a blockchain, such that the updated blockchain token based graph mirrors the updated blockchain. Thus, changes in liquidity sources may lead to additions or removals of edges, or updates to the properties of edges between tokens on the blockchain token based graph. Generally, updating the blockchain token based graph S116 may occur in response to newly gathered blockchain data by block S110. Additionally or alternatively, updating the blockchain token based graph S116 may commit updates based on user implemented changes, and/or from data from other sources.

In one example of updating the blockchain token based graph S116; as part of gathering blockchain data S110, a local copy of a subset of the blockchain state may be kept for further computation. A blockchain state is updated by its corresponding mechanism, where the state of liquidity sources may also change. Thus, to stay relevant, the local state of the blockchain token based graph must be updated periodically by connecting to the blockchain, in correspondence to that blockchain being updated (e.g., addition of a new block to a blockchain).

In some implementations, a WebSocket or other blockchain monitoring mechanism may be set up to watch for changes in the subset of the blockchain state that pertains to the liquidity source(s) of interest. This monitoring mechanism may directly connect to a node in the corresponding blockchain network, or alternatively may utilize a third-party service to monitor changes in the blockchain state. When such a change is detected, that change can also be applied to the locally kept state, allowing the local state to mirror the current blockchain state in an efficient manner.

Updating the blockchain token based graph S116, may include pruning the graph. Pruning the graph functions to remove edges, nodes, and/or token exchanges of the blockchain token based graph (referred to as removing segments). Removing segments functions to simplify blockchain token based graph by removing suboptimal nodes, edges, and/or token exchanges; potentially reducing the complexity of graph circumnavigation. Pruning the graph may occur at any time after the blockchain token based graph has been generated. This may be particularly useful after the initializing the blockchain token based graph S120, where constraints and boundaries of the circumnavigation have been set, and during each iteration of constructing the method circumnavigation S130, where exchange efficiencies may be used to determine suboptimal exchanges.

In some variations, pruning the graph may comprise removing suboptimal edges and associated nodes. Pruning of suboptimal edges may occur in conjunction with constructing the method circumnavigation S130. In some examples, pruning suboptimal edges may occur in conjunction with an iteration of constructing the method circumnavigation S130; where exchange efficiencies for token exchanges may be leveraged to determine suboptimal edges. As iterations of the gradient descent are applied to the graph traversal, the distribution of token values sent along each edge may increase or decrease as part of updating the cycle node distribution S136. Once the token value sent along a certain edge decreases below a certain threshold (e.g., 001% of the token value of the originating node), that edge and potential corresponding nodes may be pruned from the blockchain token based graph.

In some variations, pruning the graph may comprise removing suboptimal token exchanges. Pruning suboptimal token exchanges may occur in conjunction with simulating all circumnavigations S132. Removing suboptimal token exchanges may be similar to removing suboptimal edges. In these variations, an edge may allow sufficiently optimal token exchanges at certain stages of a traversal and may enable suboptimal token exchanges at other stages of the traversal. Removing suboptimal token exchanges may thus enable removal of specific token exchanges along an edge while allowing other token exchanges along the same edge.

In some variations, pruning the graph may comprise pruning edges or swaps with insufficient liquidity. In these variations, edges representing liquidity sources that do not contain sufficient liquidity for a desired token exchange amount may be removed. Pruning edges or token exchanges with insufficient liquidity may occur directly after the generating the blockchain token based graph S110, after initializing a circumnavigation process S120, and/or during or constructing a method circumnavigation S130.

In many variations, generating a blockchain token based graph S110 may not include every possible liquidity source on all considered blockchains, but may preferably include only relevant liquidity sources (e.g., liquidity sources that may be used for a valid circumnavigation path with the desired initial conditions). In some variations, user desired liquidity sources may be added, removed, or prioritized, through the initial process of creating the blockchain token based graph S114 and/or through updating the blockchain token based graph S116 Relevant liquidity sources may include liquidity sources: that could be included in at least one possible circumnavigation path, can be accessed with a limitation of the maximum number exchanges, have sufficient amount of liquidity for the exchange, or have some other qualifying metric for the circumnavigation.

Block S120, which includes initializing a circumnavigation process, functions to set the initial conditions, constraints, and the circumnavigation parameters. Initializing a circumnavigation process S120 may include, determining a cycle node S122, determining a circumnavigation length S124, determining all circumnavigation paths S126, and determining a cycle node distribution S128. As per desired implementation, initializing a circumnavigation process S120 may include additional or alternative initial conditions, constraints, and/or parameters. Additional conditions may include: the calculation and construction of additional data structures, such as calculating and storing the minimum number of edges needed for a circumnavigation to pass through a desired intermediary node; incorporation of a node traversal cost (e.g., GAS cost on Ethereum), time constraints for a graph circumnavigation (e.g., as compared to the rate that a blockchain may update); inclusion or removal of desired or undesired intermediary tokens; omission of tokens seeing low usage (as they are unlikely to provide sufficient liquidity to give a better route); etc. In one example, initializing a circumnavigation process S120 may include determining a blockchain state change time frame, comprising the time until the blockchain is updated.

\Block S122, which includes determining a cycle node functions to set and/or determine the start and end node for the circumnavigation process, i.e., the cycle node. Dependent on implementation, the cycle node may be either user defined or determined by the method. As a method determined node, the cycle node may be determined in any desired context. For example, in one variation, the cycle node may be set by accessing a user wallet, and setting the cycle node to be the node for any token ‘stored’ in the wallet. In another variation, for a ‘full’ graph analysis, the cycle node may be methodically chosen, one-by-one, from blockchain token based graph, wherein a circumnavigation for each node as a cycle node will be analyzed. In other variations, the cycle node may be determined from their corresponding liquidity pools. For example, the cycle node may be chosen that is connected to a particularly favorable liquidity pool, that has a minimum amount of liquidity, etc.

Initializing a circumnavigation process S120 may include determining a circumnavigation length S124. Determining a circumnavigation length S124 may function to set and/or determine a maximum number of intermediary nodes that may be traversed as part of the circumnavigation process. Determining a circumnavigation length S124 may be dependent on implementation, and any general method for determining a number of intermediary nodes. For example, in one variation, determining a circumnavigation length S124 may comprise receiving a user input, MAXSTEPS (i.e., receiving a user-defined maximum number of intermediary nodes/steps plus 1). As used herein ‘MAXSTEPS’ may be used interchangeably with the ‘circumnavigation length’, wherein the MAXSTEPS (or maximum steps) is a value one greater than the circumnavigation length. In another variation, determining a circumnavigation length S124, may comprise iterating the method for different circumnavigation lengths, serially or in parallel, until an optimal circumnavigation length is determined. For example, the method may be implemented first for 2 MAXSTEPS, then 3 MAXSTEPS, 4 MAXSTEPS, etc.; up to some upper bound maximum steps (e.g., an upper bound set by transaction cost on the blockchain), and then the best solution found can be taken. As a common result for this calculation, in many variations, searching values for MAXSTEPS between 6 intermediary tokens and 1 intermediary token generally yield the best solutions, since this allows enough intermediary steps for complexity but does not consider extra-long paths that would accrue large fees that may be expensive to execute on (as well as being expensive to optimize).

Block S126, which includes determining all circumnavigation paths, functions to leverage initial conditions and constraints (e.g., the cycle node and the circumnavigation length) to determine all possible circumnavigation graph traversals with fewer than MAXSTEPS intermediary node traversals, that may be accomplished, starting and ending at the cycle node. For example FIG. 5, with a circumnavigation length 3, determining all circumnavigation paths S126 would determine the paths: A->B->A; A->C->A; A->B->C->A; A->C->B->A; A->B->C->B->A; and A->C->B-C->A. As described above, once all circumnavigation paths have been determined, updating the blockchain token based graph S116 may be called to remove all nodes and edges that are not part of any circumnavigation.

Block S128, which includes determining a cycle node distribution S128, functions to set how the cycle node token value is distributed between each node along all circumnavigation paths. The method simulates traversal of all circumnavigation paths as determined by block S126, wherein determining a cycle node distribution S126 sets how the token value is split along each edge to neighboring nodes during the circumnavigation. That is, determining a cycle node distribution S126 sets both how the token value will be distributed, and the initial cycle node distribution. In taking a path step (i.e., traversal of the blockchain token based graph from one origin node to all eligible target nodes), each node token value is split between all edges to neighboring destination nodes. Dependent on implementation, determining a cycle node distribution S126 may use any distribution function to split the value of an origin node between all connecting exchange edges. In one variation, the origin node token value is divided evenly along all paths. For example, the token value of the origin node is split/divided evenly by three to pass to three destination nodes. In another variation, a ‘SoftMax’ function is taken over each origin node tensor dimension, such that the token value at that node can be split proportionally. The amount sent along each edge may then be the output of the SoftMax function multiplied by the token value of the origin node. The amount sent along each edge may then be passed into that edge's AMM function. In other variations, other desired distributions may be utilized in splitting origin node token values. The method of splitting the values of nodes may be changed over iterations. For example, in earlier iterations, splitting the token value may include dividing the token value depending on path densities (i.e., ratio of number of circumnavigation paths that include that path step), wherein later iterations would use ‘SoftMax’ function.

Block S130, which includes constructing a method circumnavigation, functions to determine a ‘best’ circumnavigation path. In many variations, constructing a method circumnavigation S130, comprises an iterative process to determine the best circumnavigation path (i.e., the method circumnavigation). For each iteration, constructing a method circumnavigation S130 functions in executing all circumnavigation paths then determining a swap efficiency for each traversal step for all circumnavigation paths, and incrementally updating the cycle node distribution, based on the swap efficiencies, for the following iteration of constructing a method circumnavigation. Thus, each iteration of constructing a method circumnavigation may include: simulating all circumnavigation paths S132, calculating an exchange efficiency S134, for each path step of each graph circumnavigations; and using the exchange efficiency, updating the cycle node distribution S136. By iterating constructing a method circumnavigation S130, the method may incrementally approach, and thus determine, the method circumnavigation. As blocks S132, S134, and S136 are called iteratively, for each iterated traversal, the constructed circumnavigations are incremented towards the more efficient swap paths as determined from the prior iteration. In this manner, constructing a method circumnavigation S130 comprises a stepwise loop of simulated graph circumnavigations, wherein the graph circumnavigations incrementally approach the method circumnavigation.

Block S132, which includes simulating all circumnavigation paths, functions to implement all eligible circumnavigations. Simulating all circumnavigation paths S140 may be an iterative process that will be repeatedly called. Initially, simulating all circumnavigation paths S140 functions to execute all circumnavigation paths on the blockchain token based graph (as determined by block S126) using the initial cycle node distribution (as determined by block S128). In subsequent iterations, updating the blockchain token based graph S116 may prune circumnavigation paths. Thus, simulating all circumnavigation paths may then comprise executing all currently eligible circumnavigation paths using the current cycle node distribution.

Simulating all circumnavigation paths S132 may comprise taking a series of path steps, wherein each path step (also referred to as traversal step or time step) includes a graph traversal from a first node (i.e., origin node) to all eligible neighboring nodes (i.e., target nodes). As a constraint for the circumnavigation the first path step for any circumnavigation would include one of the cycle nodes as the origin node, and the final path step for any circumnavigation would include one of the cycle nodes as the target node. Through each iteration of simulating all circumnavigation paths S132, the cycle node distribution for each path step may be incrementally improved.

For example, the cycle token value may be initially distributed evenly, randomly, or in some other computationally cheap method, between all traversal paths, and then, per each traversal step, incremented towards the more efficient traversal paths. Individual path steps are taken, node to node (origin node to target node). Generally, each path step includes taking all nodes with a positive token value (origin nodes) and splitting/distributing the token value of each origin node along all connected edges to the neighboring target node. The splitting/distributing of each origin node is done as prescribed by the cycle node distribution. In many variations the transferred token value to all connected nodes occurs through the “amount out” function of the corresponding edge. This can serve to simulate propagating potential exchanges to evaluate impacted token value for a given potential executed exchange.

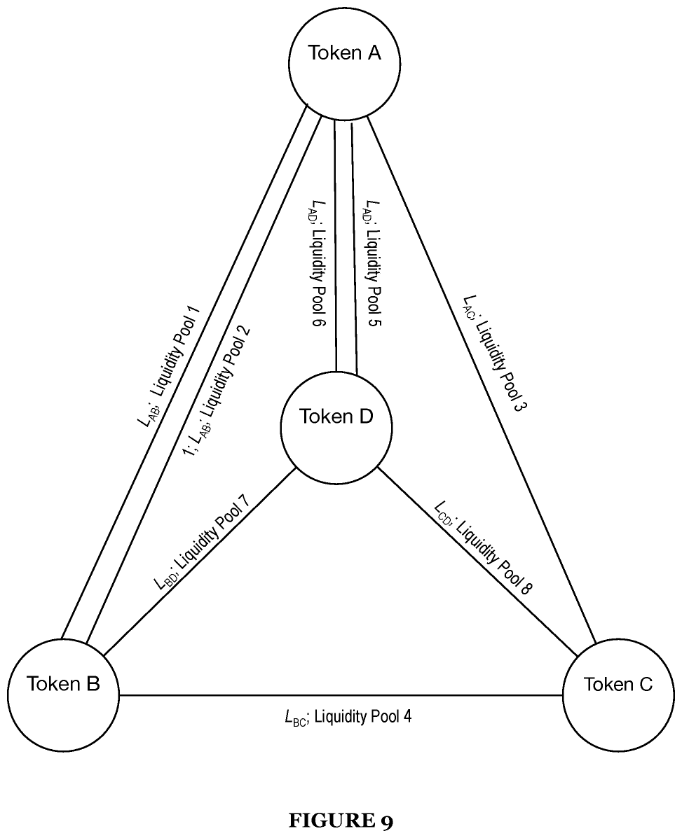

Initially, as shown in example FIG. 7, only the cycle token(s) has a non-zero value. Taking the initial path step (from time=0 to time=1) includes distributing the cycle token value and transferring it to all neighboring nodes. Thus, for this example the token value of token A is distributed along edge 1, edge 2, and edge 3 and eventually transferred to token B and token C. In another example, as shown in FIG. 9, the token value of token A is split five ways: two edges going to token B, one edge going to token C, and two edges going to token D. Taking the initial path step (from time=0 to time=1) includes splitting the start token value and transferring it to all neighboring nodes.

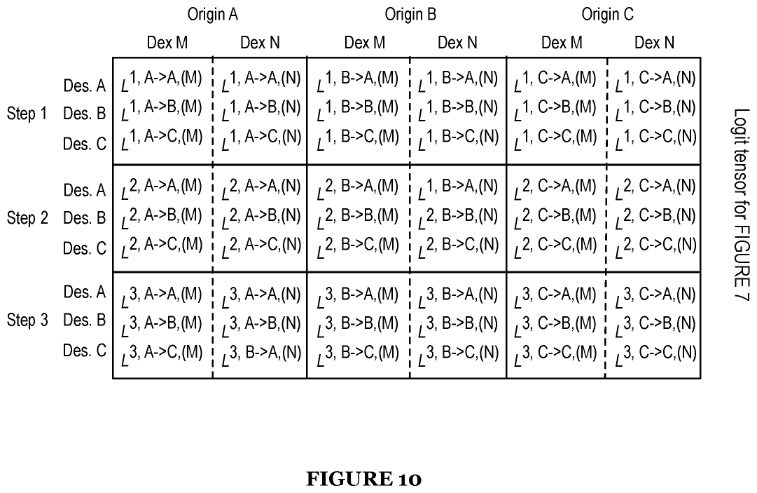

It should be noted that the liquidity pools (edges) are AMM functions obtained from the liquidity sources on the blockchain (e.g., a DEX.) These functions may be dependent on the token properties (e.g., smart contract rules), the amount of token exchanged through the associated liquidity pool, and other local parameters of the liquidity source (e.g. local variables in the DEX smart contract). As shown in example FIG. 10, edges may be mathematically represented as rank 4 logit tensors L^{αβμv}, where the indices refer to: the path step number (α), the origin node of the edge (β), the destination node of the edge (μ), and the liquidity pools (e.g., DEX) (v). The path step number ranges from 1 to MAXSTEPS. The origin node and destination node values range from 1 to S, where S is the total number of tokens on the blockchain token based graph. The liquidity pools range from 1 to T, where T is the total number of liquidity pools, or liquidity sources, the method is using.

Block S134, which includes calculating an exchange efficiency, functions in determining the exchange efficiency (or swap efficiency) for each token swap for along all circumnavigation paths. For each taken path step, the exchange efficiencies may provide the comparative favorability of all traversed edges. Any desired metric may be incorporated for calculating an exchange efficiency S134. In many variations, calculating an exchange efficiency S134, includes applying a gradient descent to all token swaps traversed during the iteration of block S130, thereby calculating all traversal exchange efficiencies of all token swaps of all path steps for the current iteration. In many variations, the gradient descent is determined with respect to the same dimensions as the edge tensors. For example, for each edge of a swap path, the gradient descent may be calculated across dimensions of the origin node, destination node, path step, and potentially liquidity source (e.g., origin DEX of the edge). Calculating an exchange efficiency S134, may occur concurrent, or after simulating all circumnavigation paths S132. That is, for each path step traversed during block S132, a complementary sub-step of block S134 may occur concurrently. Alternatively, all circumnavigation paths may be simulated as per block S132, and then the exchange efficiencies for each path step of all the circumnavigation paths may be calculated.

Block S134, which includes updating the cycle node distribution S134 may function in incorporating calculated exchange efficiencies in future iterations of constructing the method circumnavigation S130. That is, the exchange efficiencies of each token swap may be incorporated in how later iterations of the same token swap are generated via updating the cycle node distribution S134. In variations that include a SoftMax function, the SoftMax function may incorporate the prior iteration swap efficiencies to determine the distribution of token values between neighboring nodes. For example, in a first iteration of block S130, the SoftMax function cycle node distribution may evenly divide the token value of an origin node between all destination nodes. On later iterations, the SoftMax function may use the exchange efficiencies of the edge traversals from the origin node to destination nodes, of the prior iteration to distribute the token values. In this manner, a gradient descent efficiency, may iteratively maximize (or minimize) favorable swaps.

Through of updating the cycle node distribution S136, the method may iteratively “move” the process to the most favorable circumnavigation, i.e., the method circumnavigation. As this occurs, by further removal of what are determined to be “inefficient” nodes, edges, and token exchanges, constructing the method circumnavigation S130 may be improved. By calculating an exchange efficiency S132, suboptimal paths may be identified for removal (i.e., pruning). Thus, updating the cycle node distribution S132 may include pruning of nodes, edges, and token exchanges (i.e., pruning of segments), such that circumnavigation paths that included the segments are thereby removed. Pruning suboptimal paths may simplify and speed up graph traversals. Pruning may occur because the amount of value traveling along the edge at a certain path step is negligible, or the value may be non-negligible, but the edge does not provide as much value as the cost to initiate the exchange (e.g., GAS cost on Ethereum).

In some variations, updating the blockchain token based graph S116 may also be called to remove the suboptimal node, edge, and/or token exchange from the blockchain token based graph. As block S132 determines the relative favorability of each edge, updating the blockchain token based graph S116 may be called to prune edges, intermediary nodes, and/or token exchanges, that are determined to be sufficiently unfavorable.

Dependent on implementation, the current iteration of block S130 may be repeated after pruning. That is after pruning of a certain segment, the cycle node distribution may be updated to take into account for the removals of any nodes, edges, or token exchanges, wherein the distributed token values of pruned segments would be normalized to take into account the removal of any nodes, edges, or token exchanges, without updating the relative exchange efficiencies of the cycle node distribution.

Alternatively, once the blockchain token based graph has been pruned, the current path step, may be repeated. The current path step may be reset, but without the segment. The token value would be normalized, taking into account the removed node, edge, or token exchange. The current path step may then be repeated. If all nodes, edges, and token exchange of the step are then determined to be sufficiently favorable, then the next step-wise process of simulating all circumnavigation steps S132 may be continued.

Any desired method may be used to determine if regions of the blockchain token based graph are sufficiently unfavorable for pruning. For example, the proportion of token “flow” through each node, edge, or token exchange may be used to remove nodes, edges, or swaps. That is, the proportion of the original token input amount flowing through each node, edge, or exchange is calculated. Nodes, edges, or exchanges below a certain proportion of flow may then be pruned. In another example, the gradients of flow through each node, edge, or token exchange may be used to determine pruning.

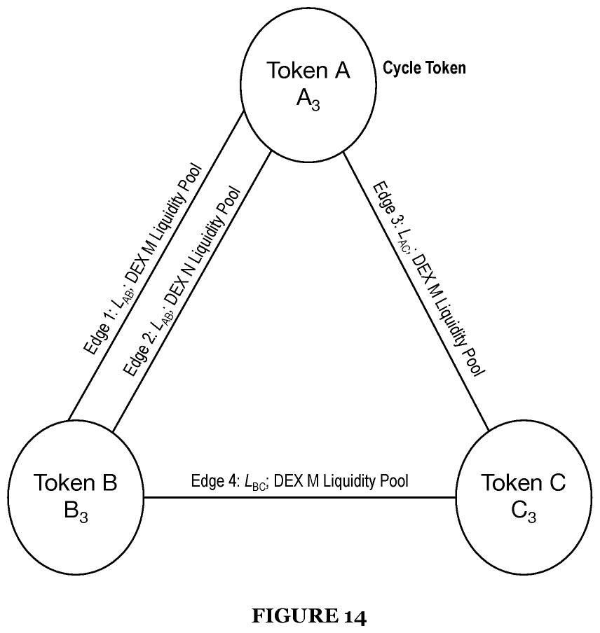

FIGS. 7 and 10-14 provide an example of an of simulating all paths, for blockchain token based graph comprising: three nodes, token A, B, and C; located on two DEXs, DEX M and DEX N on a single blockchain, where all three nodes are interconnected. For this first simplified example, no constraints are implemented, thus all potential paths of a certain length will be explored without implementing a circumnavigation constraint. The general tensor formulation for the traversal parameters is provided in FIG. 10. In some implementations an explicit representation of this tensor format may be used, while in other implementations an implicit representation may be used; e.g., a sparse tensor representation may be used, wherein tensor elements that are negligible are not included. For simplicity, this example will not include pruning of nodes, edges, or token exchanges. Splitting of token values may be incorporated by a simplified cycle node distribution between all connected edges. For example, a SOFTMAX function may be implemented to split the value of each token to transfer to each edge.

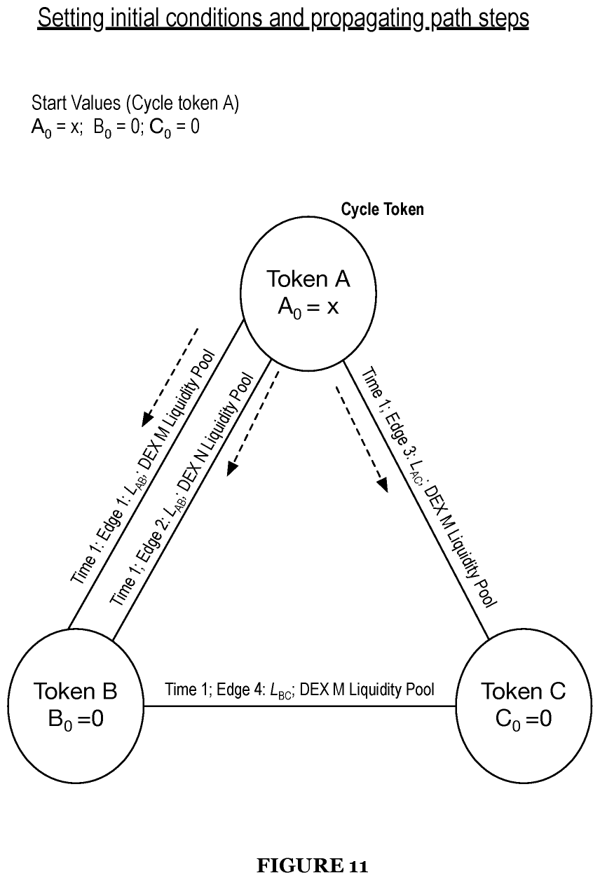

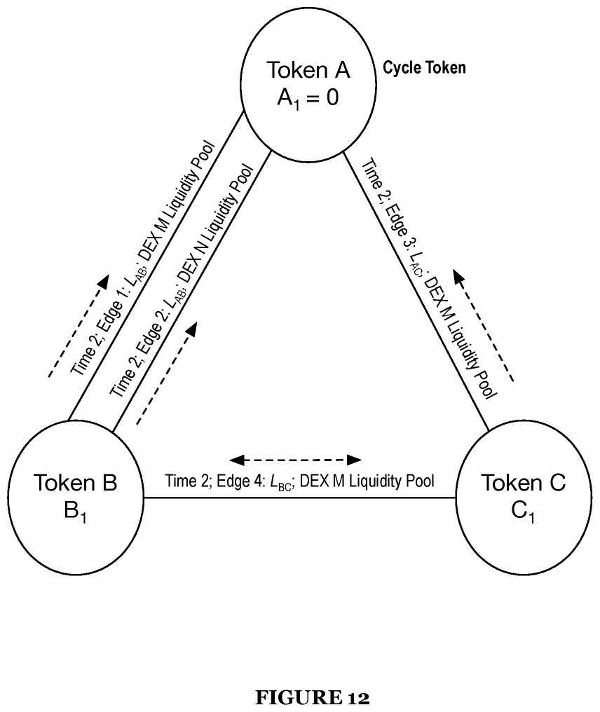

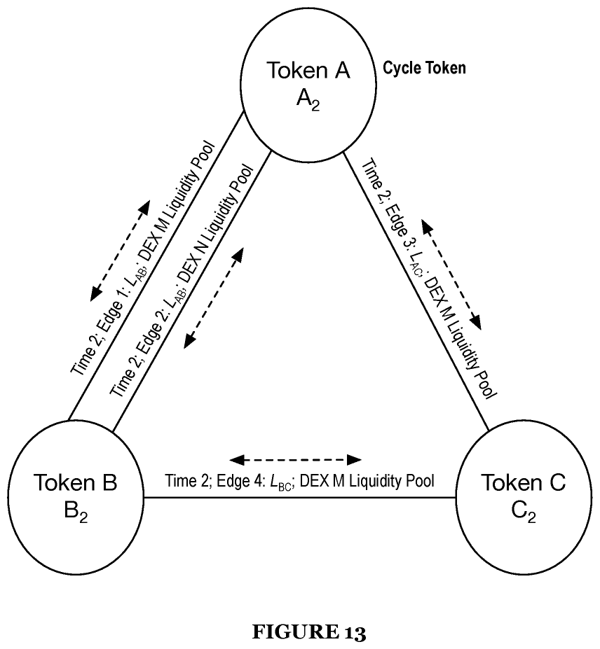

As shown in FIG. 11, at the initial time step, only the cycle token A has a non-zero value. Thus, the initial path step, comprises splitting the cycle token value between all edges connected to token A, sending value to token B and token C. It should be noted that in implementations that include only a single cycle token, after the first path step, the value of the cycle token is approximately 0, since the entire token value was distributed between neighboring nodes. As shown in FIG. 12, the second path step includes splitting token B as set by the cycle node distribution (e.g., by using a SOFTMAX function), to send to token C and back to token A; and splitting token C, to send to token B and back to token A. As shown in FIGS. 13, for path step 3, all tokens are sent to all neighboring tokens. As a simplified example, as shown in FIGS. 13, after the final path step, since the appropriate paths have not been pruned, all tokens may have non-zero values.

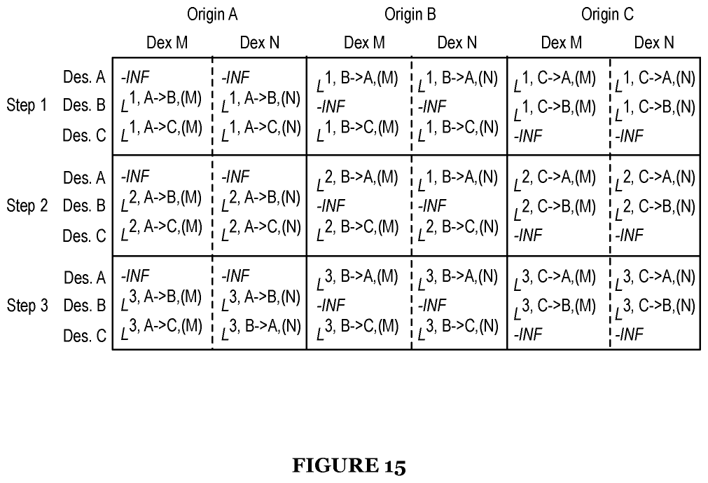

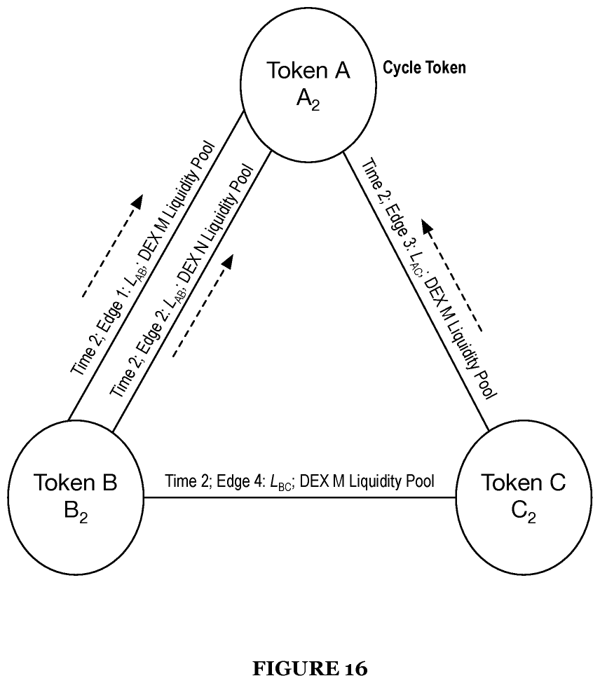

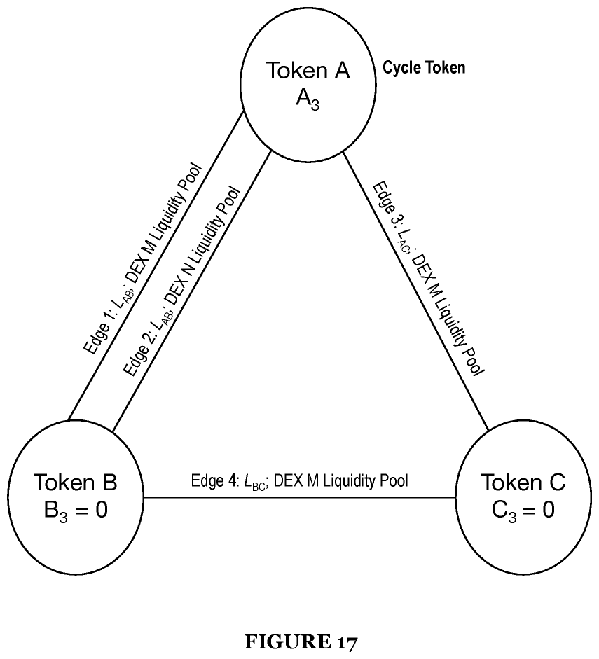

In a general circumnavigation implementation, constraints may be incorporated in the blockchain token based graph (e.g., to not include nodes and edges that are out of range), in the cycle node distribution (e.g., enforcing a circumnavigation instead of a complete graph exploration as shown in the example above), and/or the edge logit tensor. As shown in FIG. 15, certain exchanges in the blockchain token based graph traversal may be removed to improve the calculation, or because they can't be traversed on that step while satisfying all traversal rules. In many implementations, the edges are not actually removed, but set to a value such that a traversal along that edge would not occur (e.g., set to negative infinity for this example calculation). For the initial path step, edges not originating from the cycle token may be removed. Since after the path step the cycle token value is relatively zero, for the second path step, originating from the cycle token may be removed. Since only the cycle token should be non-zero after the final path step, all exchanges not ending at the target token should be removed. More generally, for larger more complex graphs, updating the blockchain token based graph S116 may remove exchanges whose destination token would create a circumnavigation path that cannot be completed within the circumnavigation length. In many implementations, As set by the chart in FIG. 15 and the graph shown in FIG. 16 prior to the final path step, only the edges leading to the target token are allowed; thus, as shown in FIG. 17, only the cycle token is non-zero.

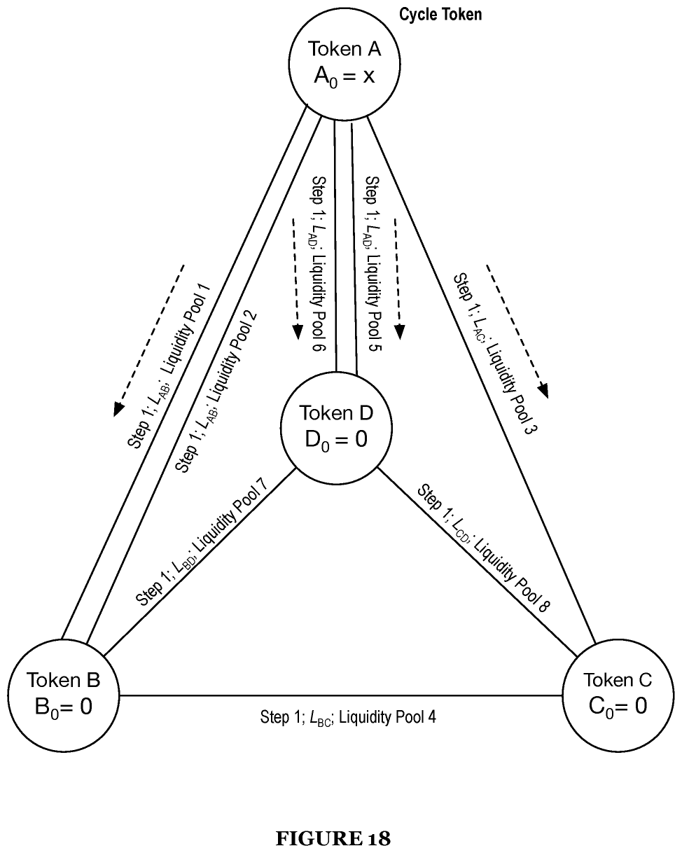

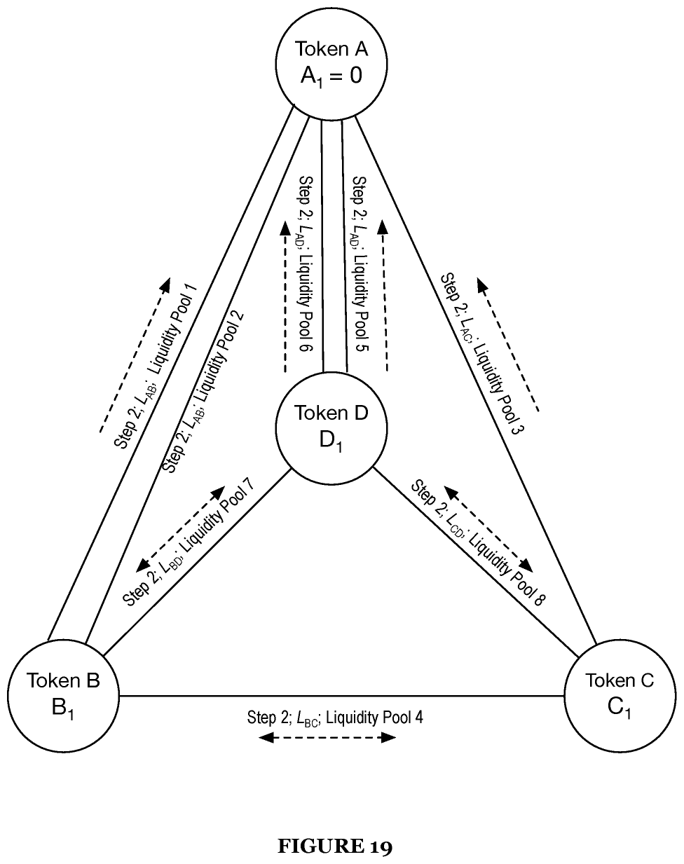

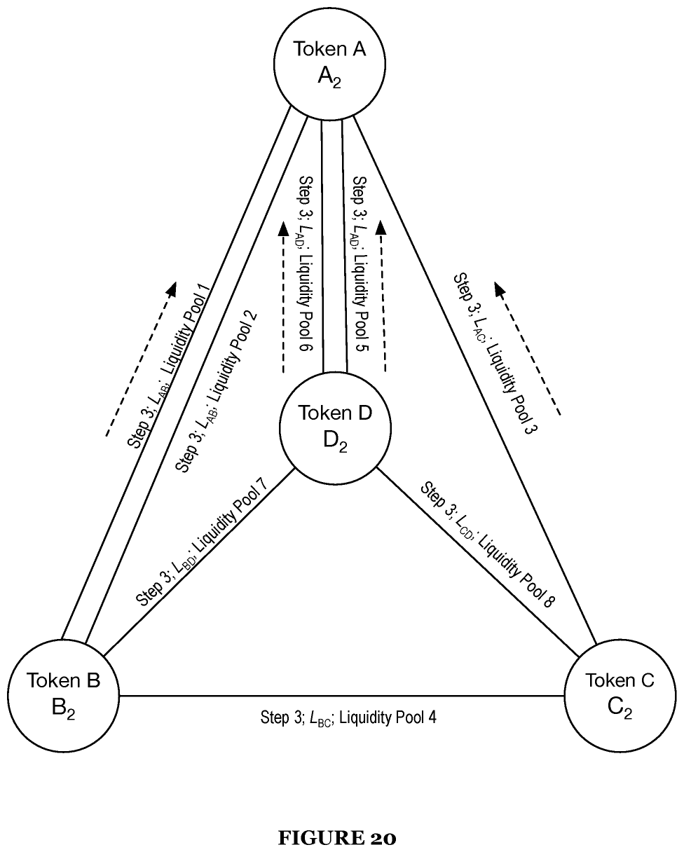

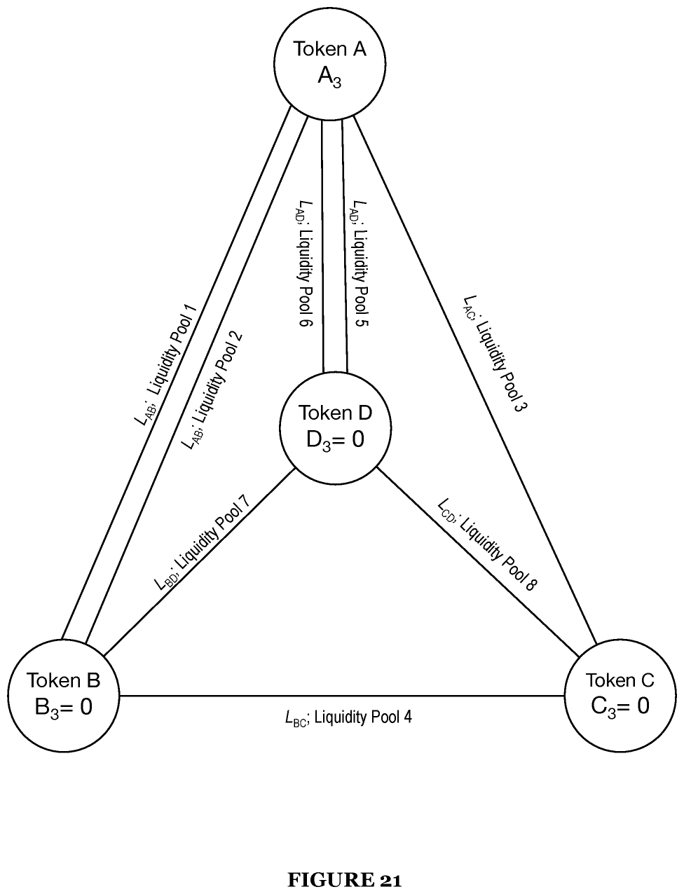

Another example is shown in FIGS. 9 and 18-21, for four interconnected tokens and a circumnavigation length of 2. Starting with the cycle token (A), the value of token A is distributed between neighboring edges, with the value ending up at all connected nodes (token B, token C, and token D). Since the value of token A is now 0 as shown in FIG. 19, during the next path step all other tokens split their values between their neighboring edges, with value ending up at the connected nodes. That is, token B distributes its value between the exchanges going to token A, token B, token C, and token D (i.e., the two exchanges going to token A, the single exchange to token C, and the single exchange going to token D). In the same manner token C distributes its value between the exchanges going to token A, token B, and token D, and token D distributes its value between the exchanges going to token A, token B, and token C. As shown in FIG. 20, during the final step, there are additional restrictions on graph traversal, such that for the final path step only exchanges to the cycle token (token A) are allowed.

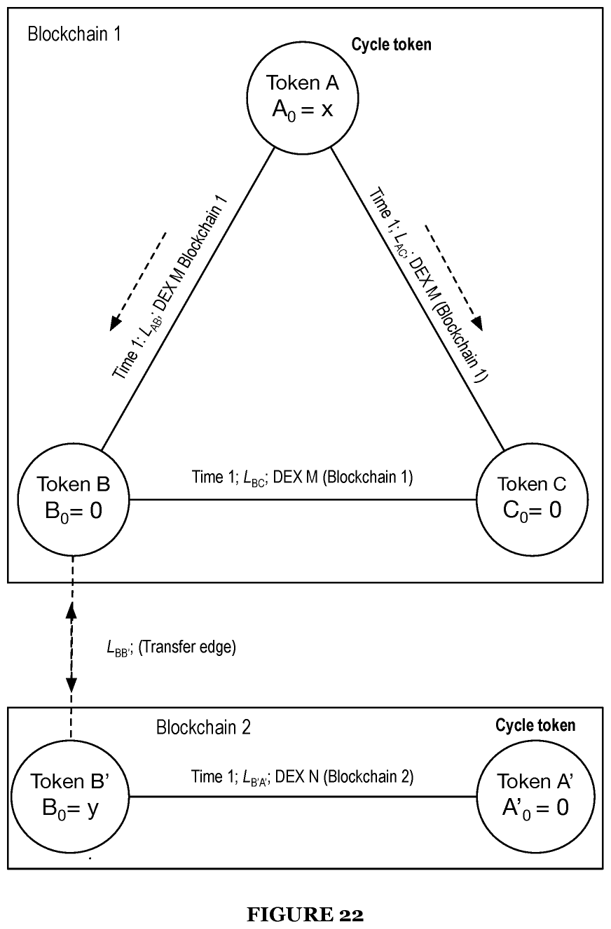

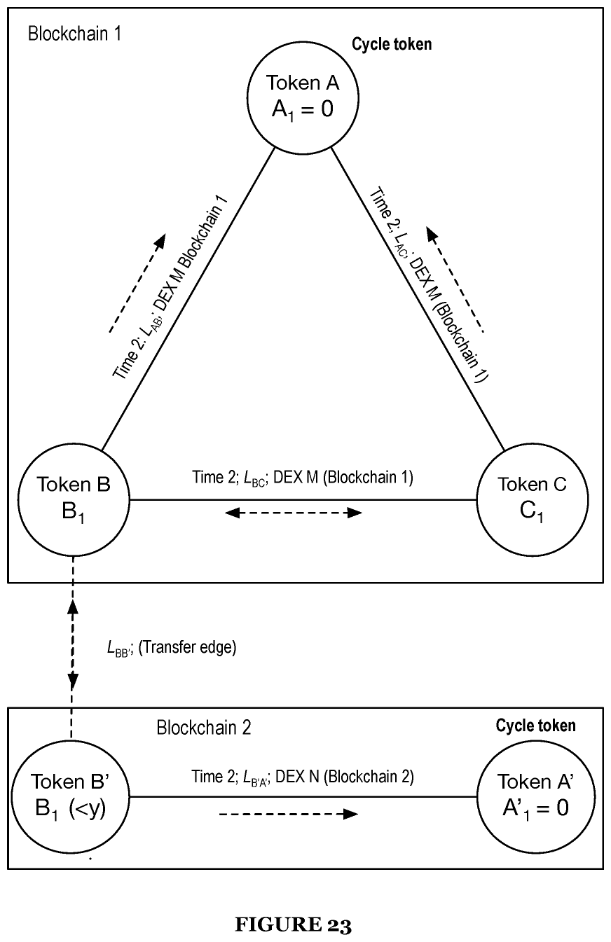

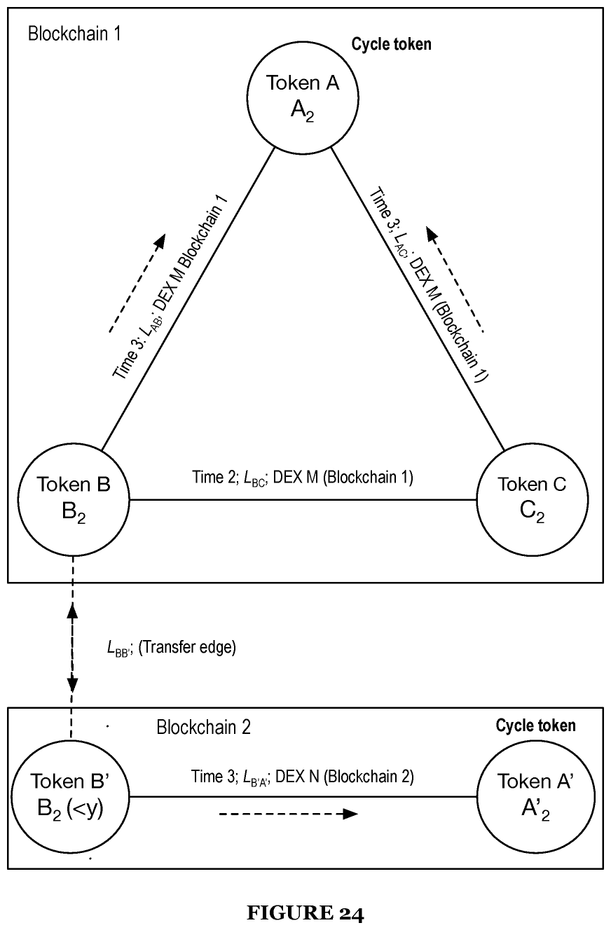

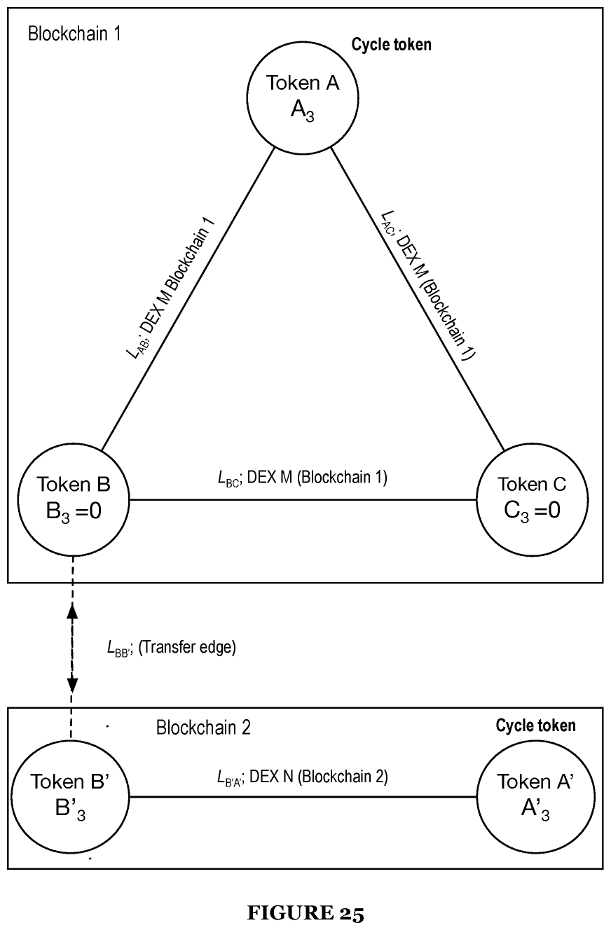

In a third example, as shown in FIGS. 22-25 three distinct tokens are connected on two separate blockchains, where two tokens (token A and token B) are present on both blockchains (referred to as token A′ and token B′ on the 2^{nd} blockchain) in a three step process with cycle token A. As part of a blockchain implementation, the method further requires that the user has tokens on both blockchains (e.g., a user has a wallet with tokens on both blockchain 1 and blockchain 2), or that the routing contract on each blockchain can acquire its respective required amount of starting token through another method. Thus, although token A is the cycle token, token B′ must also have a non-zero value to enable exchanges on the 2^{nd} blockchain (i.e., a value y). The first path step includes sending the value of token A to token B and token C on the 1^{st} blockchain. As shown in FIG. 23, during the second path step the token value of B (and B′) is sent to token A, to token C, and to token A′. A SOFTMAX function may be implemented to distribute the values of the tokens, with the additional constraint that for this exchange to occur, the token value B′ (i.e., y) is greater than or equal to the amount that is to be sent to token A′. The third time step occurs in an analogous fashion, where all distributed amounts on the second blockchain must be less than the amount held on the second blockchain (i.e., token B′) at the start of the process. Dependent on the amount distributed on the final time step, the final value of token B′ may not in fact be zero, but simply the difference of the initial value of token B′ and the amount of token B′ sent to token A′. In this multiple blockchain example, the circumnavigation path may have both non-zero values of token A and token A′.

In this example, token B′ has a non-zero token value. As the transfer edge between token B and token B′ is not an actual exchange, either an external exchange must be incorporated to enable transfer between the two, or the token must be user accessible. For this example, it is assumed that a value ‘y’ of token value B′ is owned by the user, and that all distributions sent through token B and token B′ are less than this token value y.

### 3. System Architecture

The systems and methods of the embodiments can be embodied and/or implemented at least in part as a machine configured to receive a computer-readable medium storing computer-readable instructions and an external communication device. The instructions can be executed by computer-executable components integrated with the application, applet, host, server, network, website, communication service, communication interface, hardware/firmware/software elements of a user computer or mobile device, wristband, smartphone, or any suitable combination thereof. The communication device is specifically configured to send and receive computer-readable instructions to and from blockchain platforms. Communication may be through proprietary protocols, APIs, web browser, or any other form of appropriate communication. Other systems and methods of the embodiment can be embodied and/or implemented at least in part as a machine configured to receive a computer-readable medium storing computer-readable instructions. The instructions can be executed by computer-executable components integrated with apparatuses and networks of the type described above. The computer-readable medium can be stored on any suitable computer readable media such as RAMs, ROMs, flash memory, EEPROMs, optical devices (CD or DVD), hard drives, floppy drives, cloud storage systems, or any suitable device. The computer-executable component can be a processor, but any suitable dedicated hardware device can (alternatively or additionally) execute the instructions.

In one variation, a system comprising of one or more computer-readable mediums storing instructions that, when executed by the one or more computer processors, cause a computing platform to perform operations comprising those of the system or method described herein such as: at a communication interface, connecting to a DLT source; at a storage medium generating a blockchain token based graph; at a processor system configured to perform continuous iterative processing of a graph, constructing a method circumnavigation; at a processor system configured to perform continuous iterative processing of a graph, pruning the graph, thereby removing negligible paths from the blockchain token based graph; and at a processor system configured to perform continuous iterative processing of a graph, applying a gradient descent to the graph traversal.

Similarly, in another variation, a non-transitory computer-readable medium storing instructions that, when executed by one or more computer processors of a computing platform, cause the computing platform to perform operations of the system or method described herein such as: at a communication device, connecting to a blockchain or other database to read the state of one or more liquidity sources; at a storage medium generating a blockchain token based graph; at a processor system configured to perform continuous iterative processing of a graph, constructing a method circumnavigation; at a processor system configured to perform continuous iterative processing of a graph, pruning the graph, thereby removing negligible paths from the blockchain token based graph; and at a processor system configured to perform continuous iterative processing of a graph, applying a gradient descent to the graph traversal.

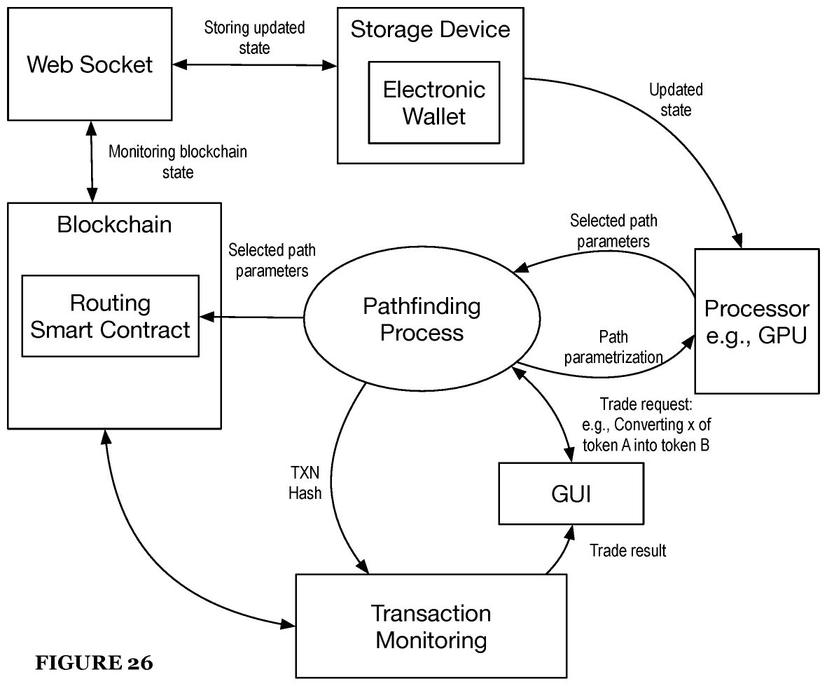

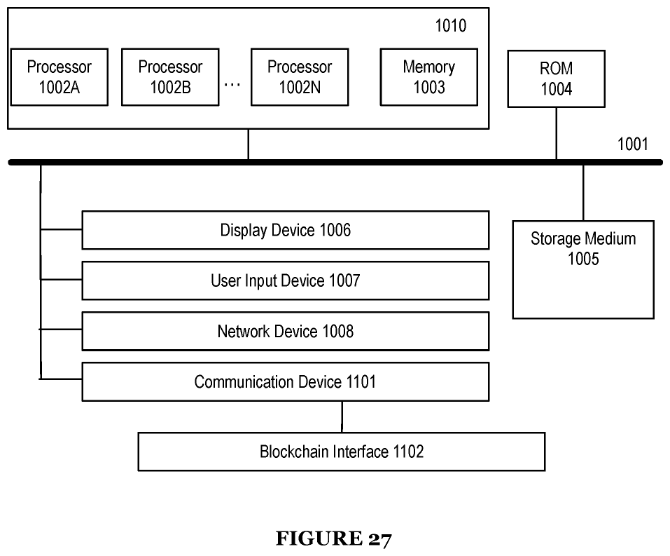

FIGS. 26 and 27 are exemplary computer architecture diagrams of two implementations of the system. In some implementations, the system is implemented in a plurality of devices in communication over a communication channel and/or network. In some implementations, the elements of the system are implemented in separate computing devices. In some implementations, two or more of the system elements are implemented in same devices. The system and portions of the system may be integrated into a computing device or system that can serve as or within the system.

The communication channel 1001 interfaces with the processors 1002A-1002N, the memory (e.g., a random-access memory (RAM)) 1003, a read only memory (ROM) 1004, a processor-readable storage medium 1005, a display device 1006, a user input device 1007, and a network device 1008. As shown, the computer infrastructure may be used in connecting a communication device 1101 that includes a blockchain interface 1102, and/or other suitable computing devices.

The processors 1002A-1002N may take many forms, such CPUs (Central Processing Units), GPUs (Graphical Processing Units), microprocessors, ML/DL (Machine Learning/Deep Learning) processing units such as a Tensor Processing Unit, FPGA (Field Programmable Gate Arrays, custom processors, and/or any suitable type of processor.

The processors 1002A-1002N and the main memory 1003 (or some sub-combination) can form a processing unit 1010. In some embodiments, the processing unit includes one or more processors communicatively coupled to one or more of a RAM, ROM, and machine-readable storage medium; the one or more processors of the processing unit receive instructions stored by the one or more of a RAM, ROM, and machine-readable storage medium via a bus; and the one or more processors execute the received instructions. In some embodiments, the processing unit is an ASIC (Application-Specific Integrated Circuit). In some embodiments, the processing unit is a SoC (System-on-Chip). In some embodiments, the processing unit includes one or more of the elements of the system.

A network device 1008 may provide one or more wired or wireless interfaces for exchanging data and commands between the system and/or other devices, such as devices of external systems. Such wired and wireless interfaces include, for example, a universal serial bus (USB) interface, Bluetooth interface, Wi-Fi interface, Ethernet interface, near field communication (NFC) interface, and the like.

Computer and/or Machine-readable executable instructions comprising of configuration for software programs (such as an operating system, application programs, and device drivers) can be stored in the memory 1003 from the processor-readable storage medium 1005, the ROM 1004 or any other data storage system.

When executed by one or more computer processors, the respective machine-executable instructions may be accessed by at least one of processors 1002A-1002N (of a processing unit 1010) via the communication channel 1001, and then executed by at least one of processors 1001A-1001N. Data, databases, data records or other stored forms data created or used by the software programs can also be stored in the memory 1003, and such data is accessed by at least one of processors 1002A-1002N during execution of the machine-executable instructions of the software programs.

The processor-readable storage medium 1005 is one of (or a combination of two or more of) a hard drive, a flash drive, a DVD, a CD, an optical disk, a floppy disk, a flash storage, a solid-state drive, a ROM, an EEPROM, an electronic circuit, a semiconductor memory device, and the like. The processor-readable storage medium 1005 can include an operating system, software programs, device drivers, and/or other suitable sub-systems or software.

In one example system architecture implementation, as shown in FIG. 26, the method may be implemented on a processor (e.g., a GPU) as an automatic market maker (AMM) pathfinding process for blockchain liquidity sources. The state of the liquidity sources may be set by connecting to a node in the blockchain's network and sending read requests for the states of the liquidity sources being considered, storing the result in a local storage medium readable by the pathfinding process. The selected path parameters and path parametrization may be set by the user interacting through a GUI, or by the process itself. A monitoring system connected to the node in the blockchain's network is used to monitor the state of the blockchain using web sockets; this system may be used to update the state stored on the local storage media, or to monitor order routing transactions. Transactions may furthermore utilize code already existing on the blockchain as smart contracts. Additionally, the system may include a storage device for the storage of private keys corresponding to the ownership of token balances on the blockchain (e.g., a wallet). Usage of the system may additionally require the user to approve the routing contract already existing on the blockchain to withdraw the desired amount of the start token from the user's balance.

As used herein, first, second, third, etc. are used to characterize and distinguish various elements, components, regions, layers and/or sections. These elements, components, regions, layers and/or sections should not be limited by these terms. Use of numerical terms may be used to distinguish one element, component, region, layer and/or section from another element, component, region, layer and/or section. Use of such numerical terms does not imply a sequence or order unless clearly indicated by the context. Such numerical references may be used interchangeable without departing from the teaching of the embodiments and variations herein.

As a person skilled in the art will recognize from the previous detailed description and from the figures and claims, modifications and changes can be made to the embodiments of the invention without departing from the scope of this invention as defined in the following claims.

We claim:

1. A method for a multi-blockchain circumnavigation process comprising:
generating a blockchain token based graph, wherein the blockchain token based graph comprises nodes representing blockchain tokens and edges representing exchanges between blockchain tokens;
initializing, on the blockchain token based graph, a circumnavigation process, comprising:
determining a cycle node, comprising setting a cycle node token value,
determining a circumnavigation length, comprising a maximum number of intermediary node traversals for circumnavigating the blockchain token based graph,
determining all circumnavigation paths, from the cycle node not exceeding the circumnavigation length, and
determining a cycle node distribution, wherein the cycle node distribution sets how the cycle node token value is distributed along each step of each circumnavigation path; and
constructing, on the blockchain token based graph, a method circumnavigation, comprising:
simulating all circumnavigations paths,
for each token exchange along all circumnavigation paths, calculating an exchange efficiency, and
based on the exchange efficiencies, updating the cycle node distribution.

2. The method of claim 1, wherein determining a cycle node comprises determining multiple cycle nodes and setting a token value for each cycle node.

3. The method of claim 2, wherein the method circumnavigation comprises at least one circumnavigation path.

4. The method of claim 3, wherein calculating an exchange efficiency comprises calculating a gradient descent.

5. The method of claim 4, wherein the gradient descent for each path step is calculated across the dimensions of an origin token, a target token, and the path step.

6. The method of claim 5, wherein the gradient descent is further calculated across the dimension of the liquidity source.

7. The method of claim 6, wherein the cycle node distribution is a SoftMax function and updating the cycle node distribution comprises using the exchange efficiencies to modify the cycle node distribution.

8. The method of claim 7, wherein generating a blockchain token based graph includes:
gathering blockchain data, by connecting to a blockchain and collecting blockchain state data;
creating, from the blockchain state data, the blockchain token based graph; and
updating the blockchain token based graph.

9. The method of claim 8, wherein each edge of the blockchain token based graph represents direction dependent automatic market maker function that defines how a corresponding liquidity source allows swaps between the token pairs.

10. The method of claim 9, wherein generating the blockchain token based graph generates a multi-blockchain token based graph that spans multiple blockchains such that nodes and edges on the blockchain token based graph represent tokens and token exchanges from multiple blockchains.

11. The method of claim 10, wherein the constructing the method circumnavigation, comprises constructing a circumnavigation that starts on the cycle node on a first blockchain and ends on the cycle node on a second blockchain.

12. The method of claim 11, wherein updating the blockchain token based graph includes determining a blockchain state change time frame, comprising the time until the blockchain state is updated.

13. The method of claim 12, wherein constructing the method circumnavigation is limited to occur in a time frame shorter than the blockchain state change time frame.

14. The method of claim 13, further comprising:
executing, on a blockchain, the method circumnavigation, comprising linking to a user wallet.

15. A non-transitory computer-readable medium storing instructions that, when executed by one or more computer processors of a computing platform, cause the computing platform to perform operations comprising:
generating a blockchain token based graph, comprising
gathering to a blockchain, thereby retrieving blockchain state data;
constructing, from blockchain state data, a blockchain token based graph, comprising nodes and edges, wherein each node represents a token on the blockchain that has a non-negative token value, and wherein each edge connects a pair of neighboring nodes representing a swap function between token pairs;
initializing a circumnavigation process, including
determining a cycle node, comprising determining a token value for the cycle node,
determining a circumnavigation length, corresponding to a maximum number of intermediary nodes that can be traversed during the circumnavigation process,
determining all circumnavigation paths, starting from and ending at the cycle node, wherein the circumnavigation path does not exceed the circumnavigation length, and
determining a cycle node distribution, wherein the cycle node distribution sets how the cycle node token value is distributed along each step of each circumnavigation path; and
at a processor system configured to perform iterative processing, constructing a method circumnavigation, comprising iteratively:
simulating all circumnavigation paths,
calculating an exchange efficiency, for each edge traversal between every node along all circumnavigation paths, and
updating, based on the exchange efficiency, the cycle node distribution.

16. The method of claim 15, wherein determining a cycle node comprises determining multiple cycle nodes and determining a token value for each cycle node.

17. The method of claim 16, wherein calculating an exchange efficiency comprises calculating a gradient descent.

18. The method of claim 17, wherein the gradient descent for each path step is calculated across the dimensions of an origin token, a target token, and the path step.

19. The method of claim 18, wherein the gradient descent is further calculated across the dimension of the liquidity source.

20. The method of claim 19, wherein the cycle node distribution is a SoftMax function and updating the cycle node distribution comprises using the exchange efficiencies to modify the cycle node distribution.

21. The method of claim 20, wherein generating a blockchain token based graph includes:
at a blockchain interface, gathering blockchain data, by connecting to a blockchain and collecting blockchain state data;
creating, from the blockchain state data, the blockchain token based graph; and
updating the blockchain token based graph.

22. A system comprising of:
one or more computer-readable mediums storing instructions that, when executed by the one or more computer processors, cause a computing platform to perform operations comprising:
generating a blockchain token based graph, including gathering blockchain data, by connecting to a blockchain source, thereby retrieving blockchain source state data, creating a blockchain token based graph from the blockchain source state data, and updating the blockchain token based graph from the blockchain source state data;
initializing a circumnavigation process, including determining a cycle node, determining a circumnavigation length, determining all circumnavigation paths starting and ending at the cycle node and not exceeding the circumnavigation length, and determining a cycle node distribution; and
at a processor system configured to perform iterative processing, constructing, iteratively, a method circumnavigation comprising: simulating all circumnavigation paths, calculating an exchange efficiency for each edge traversal along each circumnavigation path, and updating the cycle node distribution based on the exchange efficiencies.
